(19) United States
(12) Patent Application Publication
(10) Pub. No.: US 2019/0156361 A1
(43) Pub. Date: May 23, 2019

(54) System and Method for Contests, Advertising and Reward

(71) Applicant: Wewin Inc, Flushing, NY (US)

(72) Inventor: Wanjun Xie, Oakland Garden, NY (US)

(73) Assignee: Wanjun Xie, Flushing, NY (US)

(21) Appl. No.: 16/259,568

(22) Filed: Jan. 28, 2019

(51) Int. Cl. G06Q 30/02

(52) U.S. Cl. CPC G06Q 30/0209; G06Q 30/0277

(57) ABSTRACT

A system and method for contests, advertising and reward by internet and mobiles APP. Some knowledge and contents will be written to the contest questions, which fit the contests by internet and mobile APP, to hold the single contests or the mixed contests by internet and mobiles APP. Any entities and any individuals can use these contests knowledge, the contest platform, the contests and the contest questions to make their advertisements and promotions. The contest platform will set up the studying scores, the contest scores and the reward scores. The platform will operate and manage the contests by the contest scores. The company which own the platform will sign some investing agreements with some companies. According the agreements, these companies will pay a specific ratio amount of their quarter realized net profit to support the operations of the contest platform.

A system and method for contests, advertising and reward by internet and mobiles APP.

The knowledge of any enterprise, individuals, universities or colleges, organizations, groups, agencies, countries, districts, areas and cities, will be written to the contest questions, which fit the contests by internet and mobile APP, to hold the single contests or the mixed contests by internet and mobiles APP.

The knowledge and/or the contents of any movies, teleplays, television programmes, videos, dramas, entertainments, computer, mobiles, games, sports, travel, discovery, websites, news, photography, pictures, cartoons, pets, automobiles, weapon, ships, planes, drones, aviation, avigation, finance and economics, science and technology, politics, militaries, educations, fashions, beauty, food, health, intelligent quotient, literatures, arts, visual ability, remember ability, music and paints, will be written to the contest questions, which fit the contests by internet and mobile APP, to hold the single contests or the mixed contests by internet and mobiles APP.

The science knowledge of physic, chemistry, zoology, botany, microbiology, life science, geoscience, space science, astronomy, mathematics, computer science, logic science, medicine, health science, anthropology, history, geography, economics, pollical science, psychology, sociology, linguistics, archaeology, literature, philosophy, science of religion, arts and military science, will be written to the contest questions, which fit the contests by internet and mobile APP, to hold the single contests or the mixed contests by internet and mobiles APP.

Any entities and any individuals can use these contests knowledge, the contents, the contest platform, the contests and the contest questions to make their advertisements and promotions.

Any entities and any individuals can attend the competitive tender openly, to auction the qualification that their knowledge and/or contents will be used in the contests, to hold the single contests or the mixed contests by internet and mobile APP.

Any entities and any individuals can cooperate with the platform by some ways, to gain the qualification that their knowledge and/or contents will be used in the contests, to hold the single contests or the mixed contests by internet and mobile APP.

The studying scores, the contest scores and the reward scores will be set up and operated. The studying scores, the contest scores and the reward scores can't be exchanged to any currencies. The studying scores, the contest scores and the reward scores can't be exchanged to each other. The contest scores don't have any value. The contest scores can't be exchanged to any valuable stuff. The reward scores can be exchanged to some products, some services, some contesting medals and/or some participating units of the companies' sharing-profit agreements.

The company which own the platform will sign some investing agreements with some companies. According the agreements, these companies will pay a specific ratio amount of their quarter realized net profit to support the operations of the contest platform.

### BACKGROUND OF THE INVENTION

Because it is sterile to study some knowledge, and answer some questions about the knowledge, so almost persons don't like to attend these contests.

There aren't power to set up and operation the contest of the knowledge by internet and mobiles APP.

### BRIEF SUMMARY OF THE INVENTION

After the reward method and system will be set up, the power will be added the contests system. For winning these contests, and gaining more valuable stuff from the contest platform, more and more persons will be hard to study the knowledge, to train their skills and abilities.

Any entities and any individuals can use these contests knowledge, the contest contents, the contest platform, the contests and the contest questions to make their advertisements and promotions.

Any entities and any individuals can attend the competitive tender openly, to auction the qualification that their knowledge can be used in the contests, to hold the single contests or the mixed contests by internet and mobile APP.

Any entities and any individuals can cooperate with the platform by some ways, to gain the qualification that their knowledge can be used in the contests, to hold the single contests or the mixed contests by internet and mobile APP.

The contest platform will be set up in internet, and any contest anticipants can attend these contests by internet and mobile APP. The inventions will be appropriate for all contest anticipants who come from global

### DETAILED DESCRIPTION OF THE INVENTION

1. The contest platform will be set up and be running by internet and mobile APP.

2. The platform will manage or link all knowledge which should be used to write the contest questions.

3. Any entities and any individuals can attend some studying and training by internet and mobile APP.

4. Any entities and any individuals can use these contests knowledge, the contest content, the contest platform, the contests and the contest questions to make their advertisements and promotions.

5. Any entities and any individuals can attend the competitive tender openly, to auction the qualification that their knowledge can be used in the contests, to hold the single contest or the mixed contests by internet and mobile APP.

6. Any entities and any individuals can cooperate with the platform by some ways, to gain the qualification that their knowledge can be used in the contests, to hold the single contest or the mixed contests by internet and mobile APP.

7. The platform should set up all kind of the question banks. The contest questions should be picked up randomly to hold each contest by computer.

8. The studying scores, the contest scores and the reward scores will be set up. The platform will use the studying scores, the contest scores and the reward scores to operate and manage the contest platform. The studying scores, the contest scores and the reward scores can't be exchanged to each other.

9. The studying scores will be used to study knowledge, to train the skills and the abilities. The studying scores can't be exchanged to any currencies.

10. The contest scores will be used to operate, manage and record the contests. The contest scores can't be purchased by any currencies. The contest scores will be presented to the contest participants as a gift in the studying process, in the contest process and in the promoting process. The contest scores don't have any value. The contest scores can't be exchanged to any currencies. The contest scores can't be exchanged to any valuable stuff.

11. The reward scores will be used to reward all winners in the contests. The reward scores can't be purchased by any currencies. The reward scores can't be exchanged to any currencies. The reward scores can be exchanged to some products, some services, some contesting medals, and/or some participating units of the companies' sharing-profit agreements.

12. The company which own the platform should sign some investing agreements with some companies. According the agreements, these companies will pay a specific ratio amount of their quarter realized net profit to support the operations of the contest platform.

13. Any contest anticipants should open their individual account. They can attend all contests in the platform, manage their contest scores and their studying scores by their account.

1. The knowledge of any enterprises, organizations, individuals, universities or colleges, groups, agencies will be written to the contest questions, which fit the contests by internet and mobile APP, to hold the single contests or the mixed contests by internet and mobiles APP.

2. Any entities and individuals can use these contests knowledge, the contest platform, the contests and the contest questions to make the advertisements and promotions for the enterprises, organizations, individuals, universities or colleges, groups, agencies.

3. Any entities and individuals can attend the competitive tender openly, to auction the qualification that the knowledge of any enterprises, organizations, individuals, universities or colleges, groups, agencies can be used in the contests, to hold the single contests or the mixed contests by internet and mobile APP.

4. The knowledge of any products, service and projects will be written to the contest questions, which fit the contests by internet and mobile APP, to hold the single contests or the mixed contests by internet and mobiles APP.

5. Any entities and individuals can use these contests knowledge, the contest platform, the contests and the contest questions to make the advertisements and promotions for the products, service and projects.

6. Any entities and individuals can attend the competitive tender openly, to auction the qualification that the knowledge of the products, service and projects can be used in the contests, to hold the single contests or the mixed contests by internet and mobile APP.

7. The knowledge and the contents of any movies, teleplays, television programme, videos, dramas, cartons, literatures, websites, entertainments, games, sports, pets, tourist attractions, museums, discovery, photography, pictures, intelligent quotients, arts, visual ability, remember ability, music, dances and paints will be written to the contest questions, which fit the contests by internet and mobile APP, to hold the single contests or the mixed contests by internet and mobiles APP.

8. Any entities and individuals can use these contests knowledge, the contest contents, the contest platform, the contests and the contest questions to make the advertisements and promotions for their movies, teleplays, television programme, videos, dramas, cartons, literatures, websites, entertainments, games, sports, pets, tourist attractions, museums, discovery, photography, pictures, intelligent quotients, arts, visual ability, remember ability, music, dances and paints.

9. Any entities and individuals can attend the competitive tender openly, to auction the qualification that the knowledge and the contents of the movies, teleplays, television programme, videos, dramas, cartons, literatures, websites, entertainments, games, sports, pets, tourist attractions, museums, discovery, photography, pictures, intelligent quotients, arts, visual ability, remember ability, music, dances and paints can be used in the contests, to hold the single contests or the mixed contests by internet and mobile APP.

10. The knowledge of any mobiles, automobiles, boats, computers, weapons, ships, planes, drones, aviation, avigation, fashions, beauty, food and health will be written to the contest questions, which fit the contests by internet and mobile APP, to hold the single contest or the mixed contests by internet and mobiles APP.

11. Any entities and individuals can use these contests knowledge, the contest platform, the contests and the contest questions to make the advertisements and promotions for their mobiles, automobiles, boats, computers, weapons, ships, planes, drones, aviation, avigation, fashions, beauty, food and health.

12. Any entities and individuals can attend the competitive tender openly, to auction the qualification that the knowledge of the mobiles, automobiles, boats, computers, weapons, ships, planes, drones, aviation, avigation, fashions, beauty, food and health can be used in the contests, to hold the single contests or the mixed contests by internet and mobile APP.

13. The knowledge of the politics, military, economics and finances, sciences and technologies, cultures, history, figures, geography, travel and religions in the world, will be written to the contest questions, which fit the contests by internet and mobile APP, to hold the single contests or the mixed contests by internet and mobiles APP.

14. The knowledge of the politics, military, economics, cultures, history, figures, geography, travel, custom, religions, districts, areas and cities in any one country, will be written to the contest questions, which fit the contests by internet and mobile APP, to hold the single contests or the mixed contests by internet and mobiles APP.

15. The science knowledge of physics, chemistry, zoology, botany, microbiology, life science, geoscience, space science, astronomy, computer science, mathematics, logic science, medicine, health science, history, geography, economic science, political science, psychology, sociology, linguistics, archaeology, literature, philosophy, science of religion, Arts and military science, will be written to the contest questions, which fit the contests by internet and mobile APP, to hold the single contests or the mixed contests by internet and mobiles APP.

16. The studying scores, the contest scores and the reward scores will be set up. The platform will use the studying scores, the contest scores and the reward scores to operate and manage the contest platform. The studying scores, the contest scores and the reward scores can't be exchanged to each other.

17. The studying scores will be used to study knowledge, to train the skills and the abilities. The studying scores can't be exchanged to any currencies.

18. The contest scores will be used to operate, manage and record the contests. The contest scores can't be purchased by any currencies. The contest participants can won the contest scores in the contest process, or the contest participants can be presented the contest scores as a gift in the studying process and in the promoting process. The contest scores don't have any value. The contest scores can't be exchanged to any currencies. The contest scores can't be exchanged to any valuable stuff.

19. The reward scores will be used to reward all winners in the contests. The reward scores can't be purchased by any currencies. The reward scores can't be exchanged to any currencies. The reward scores can be exchanged to some products, some services, some contesting medals, and/or some participating units of the companies' sharing-profit agreements.

20. The company which own the platform will sign some investing agreements with some companies. According the agreements, these companies will pay a specific ratio amount of their quarter realized net profit to support the operations of the contest platform.
